(19) United States
(12) Patent Application Publication
(10) Pub. No.: US 2026/0353279 A1
(43) Pub. Date: Nov. 5, 2026

(54) POSITIONING OF A WIRELESS COMMUNICATION DEVICE OPERATING IN DISCONNECTED MODE

(71) Applicant: Sony Group Corporation, Tokyo (JP)

(72) Inventors: Nafiseh Seyed MAZLOUM, Lund (SE); Anders BERGGREN, Lund (SE); Torgny PALENIUS, Barsebäck (SE); Basuki PRIYANTO, Lund (SE)

(21) Appl. No.: 18/997,641

(22) PCT Filed: Aug. 2, 2023
(86) PCT No.: PCT/EP2023/071482

§ 371 Date: Jan. 22, 2025

(30) Foreign Application Priority Data
Aug. 5, 2022 (SE) 2250954-1

(51) Int. Cl. H04W 52/02; H04W 64/00; H04W 76/28

(52) U.S. Cl. CPC H04W 52/0216; H04W 64/006; H04W 76/28

(57) ABSTRACT

At least one of a transmission timing of one or more transmissions of reference signals for positioning of a wireless communication device, or a timing of paging occasions is adjusted. This facilitates positioning of the wireless communication device while the wireless communication device operates in a disconnected mode, e.g., idle mode or inactive mode.

### TECHNICAL FIELD

Various aspects of the disclosure pertain to techniques related to positioning of wireless communication devices that are connectable to a cellular network. Various examples specifically relate to techniques related to positioning of wireless communication devices that operate in a disconnected mode with respect to the cellular network.

### BACKGROUND

To facilitate positioning of wireless communication devices (sometimes also referred to as user equipment, UE), multilateration and multiangulation techniques can be employed. An example of multiangulation is triangulation. Here, multiple access nodes (ANs, may be also referred to as base stations, BSs, in a cellular network, NW)—having a well-defined position in a reference coordinate system-transmit reference signals (RSs) for positioning (P-RSs). A UE can receive the PRSs and then trigger a multilateration or multiangulation. This is a scenario which corresponds to a transmission of downlink P-RSs; also, positioning based on uplink P-RSs is known.

For instance, cellular NWs operating according to the Third Generation Partnership Project (3GPP) provide positioning protocols (PPs) that enable such positioning of UEs. An example PP is the Third Generation Partnership (3GPP) Long Term Evolution (LTE) PP (LPP). See The 3GPP Technical Specification (TS) 37.355 v17.1.0.

According to reference implementations, for positioning of the UE connectable to a cellular NW, the UE must be connected to the cellular network, i.e., must operate in a connected mode. Here, a data connection between the UE and a radio-access network (RAN) part of the cellular NW is maintained. Operating in the connected mode is associated with a comparatively high energy consumption at the UE. This is the reason why there is a tendency that UEs operate in a disconnected mode in which the data connection is not maintained.

Then, there are use cases for positioning-such as tracking—where a UE is to be positioned irrespective of whether the UE operates in the connected mode or the disconnected mode. Accordingly, sometimes it can be required to position a UE while it operates in the disconnected mode. Tracking can pertain to low-power tags that could be used to track, e.g., shipping containers.

According to reference implementations, it is then possible that the UE is required to transition back and forth between the disconnected mode and the connected mode, to perform positioning measurements and report on the positioning measurements. This is particularly energy inefficient. Also, a certain time duration may be required to transition from the disconnected mode to the connected mode; accordingly, determining a location estimate may be associated with increased latency.

Release 17 of the 3GPP specification supports positioning of a UE while the UE operates in a disconnected mode, specifically, Radio Resource Control (RRC)_INACTIVE mode. Here, the UE—while still operating in the connected mode (in this case the RRC_CONNECTED mode) receives a configuration for the measurement of P-RS, e.g., downlink (DL) positioning reference signals (PRSs) and performs the positioning measurement when later on operating in an RRC_INACTIVE mode. Uplink (UL) sounding reference signal (SRS) transmissions-SRS are a specific form of PRS—can be configured in an RRC Release message that triggers the transition from the RRC_CONNECTED mode to the RRC_INACTIVE mode. A UE can still continue to transmit SRS according to the configuration when the UE operates in RRC_INACTIVE mode. A small data transmission (SDT) can be employed for configuring the UL SRS. The SDT employs resources available in messages of a random-access procedure, prior to establishing the data connection. Measurement reporting of DL PRS can also be provided using the SDT.

It has been observed that operation of a UE in the disconnected mode and implementing a positioning of the UE according to such techniques while the UE operates in a disconnected mode can cause inefficiencies in power consumption at the UE.

The following prior art is known: 3GPP document R4-2202686 “LS on DRX cycle used in PRS measurement in RRC_INACTIVE state”; and 3GPP document R2-2203607 “Email discussion Report on [AT117-e][630] [POS] Remaining proposals on RRC_INACTIVE (InterDigital)”.

### SUMMARY

A need exists for advanced techniques of facilitating positioning of a UE while the UE operates in a disconnected mode, e.g., an idle mode or an inactive mode. A need exists for techniques that facilitate positioning of a UE with reduced energy consumption at the UE and/or with reduced latency for determining the location estimate of the UE.

This need is met by the features of the independent claims. The features of the dependent claims define embodiments.

A method of operating a network node of a cellular network is disclosed. The method includes obtaining a request message for positioning of a wireless communication device. The positioning is while the wireless communication device operates in a disconnected mode. A data connection between the wireless communication device and a radio-access network part of the cellular network is not maintained in the disconnected mode. The method also includes configuring a discontinuous reception operation of the wireless communication device upon obtaining the request message. This configuring is to enable one or more transmissions of one or more reference signals for the positioning of the wireless communication device.

A network node of a cellular network, e.g., a location control node, a mobility control node, or a base station, includes at least one processor and a memory. The at least one processor is configured to load program code from the memory and execute the program code. The at least one processor is configured, upon executing the program code, to obtain a request message for positioning of a wireless communication device. The positioning is while the wireless communication device operates in a disconnected mode. A data connection between the wireless communication device and a radio-access network part of the cellular network is not maintained in the disconnected mode. The at least one processor, upon executing the program code, is further configured to configure a discontinuous reception operation of the wireless communication device upon obtaining the request message. This configuring is to enable one or more transmissions of one or more reference signals for the positioning of the wireless communication device.

A computer program or a computer-program product or a computer readable storage medium includes program code. The program code can be loaded and executed by at least one processor. The at least one processor, upon executing the program code, obtains a request message for positioning of a wireless communication device. The positioning is while the wireless communication device operates in the disconnected mode. A data connection between the wireless communication device and a radio-access network part of the cellular network is not maintained in the disconnected mode. The at least one processor, upon executing the program code, further configures a discontinuous reception operation of the wireless communication device upon obtaining the request message. This configuring is to enable one or more transmissions of one or more reference signals for the positioning of the wireless communication device.

A method of operating a network node of a cellular network is disclosed. The method includes obtaining a request message for positioning of a wireless communication device. The positioning is while the wireless communication device operates in a disconnected mode. A data connection between the wireless communication device and a radio-access network part of the cellular network is not maintained in the disconnected mode. The method also includes configuring a timing of paging occasions for paging the wireless communication device while operating in the disconnected mode in accordance with a transmission timing of one or more transmissions of one or more reference signals for positioning of the wireless communication device. The transmission timing can be predetermined by a core-network part of the cellular network.

A method of operating a network node of a cellular network is disclosed. The method includes obtaining a request message for positioning of a wireless communication device. The positioning is while the wireless communication device operates in a disconnected mode. A data connection between the wireless communication device and a radio-access network part of the cellular network is not maintained in the disconnected mode. The method also includes configuring a transmission timing of one or more transmissions of one or more reference signals for positioning of the wireless communication device. The transmission timing of the one or more transmissions of the one or more reference signals is configured in accordance with a timing of paging occasions for paging of the wireless communication device while it operates in the disconnected mode.

A method of operating a network node of a cellular network is disclosed. The method includes obtaining a request message for positioning of a wireless communication device. The positioning is while the wireless communication device operates in the disconnected mode. A data connection between the wireless communication device and a radio-access network part of the cellular network is not maintained while the wireless communication device operates in the disconnected mode. The method also includes upon obtaining the request message and depending on at least one of a transmission timing of one or more transmissions of one or more reference signals for the positioning of the wireless communication device or a timing of paging occasions of a discontinuous reception operation of the wireless communication device, configuring an uplink reporting schedule for reporting positioning measurements.

A network node of a cellular network includes at least one processor and a memory. The at least one processor is configured to load program code from the memory and execute the program code. The at least one processor is configured, upon executing the program code, to obtain a request message for positioning of a wireless communication device. The positioning is while the wireless communication device operates in the disconnected mode. A data connection between the wireless communication device and a radio-access network part of the cellular network is not maintained while the wireless communication device operates in the disconnected mode. The processsor, upon executing the program code, is further configured to configure an uplink reporting schedule for reporting positioning measurements. This is upon obtaining the request message and depending on a least one of a transmission timing of one or more transmissions of one or more reference signals for the positioning of the wireless communication device or a timing of paging occasions of a discontinuous reception operation of the wireless communication device.

A computer program or a computer-program product or a computer-readable storage medium includes program code. The program code can be loaded and executed by at least one processor. The at least one processor, upon executing the program code, obtains a request message for positioning of a wireless communication device. The positioning is while the wireless communication device operates in the disconnected mode. A data connection between the wireless communication device and a radio-access network part of the cellular network is not maintained by the wireless communication device operates in the disconnected mode. The processor, upon executing the program code, further configured an uplink reporting schedule for reporting positioning measurements. This is upon obtaining the request message and depending on a least one of a transmission timing of one or more transmissions of one or more reference signals for the positioning of the wireless communication device or a timing of paging occasions of a discontinuous reception operation of the wireless communication device.

A method of operating a wireless communication devices disclosed. The wireless communication device can be connected to a cellular network. The method includes providing a request message to the cellular network. The request messages for positioning of the wireless communication device while the wireless communication device operates in a disconnected mode. A data connection between the wireless communication device and a radio-access network part of the cellular network is not maintained while the wireless communication device operates in the disconnected mode. The request message may be provided while the wireless communication device operates in the disconnected mode, or may be provided while the wireless communication device operates in a connected mode.

A wireless communication device includes at least one processor and a memory. The at least one processor can load and execute program code from the memory. The at least one processor, upon executing the program code, is configured to provide a request message to the cellular network. The request message is for positioning of the wireless communication device while the wireless communication device operates in a disconnected mode. A data connection between the wireless communication device and a radio-access network part of the cellular network is not maintained while the wireless communication device operates in the disconnected mode. The request message may be provided while the wireless communication device operates in the disconnected mode, or may be provided while the wireless communication device operates in a connected mode. A computer program or a computer-program product or a computer-readable storage medium includes program code. The program code can be loaded and executed by at least one processor. The at least one processor, upon executing the program code, provides a request message to a cellular network. The request message is for positioning of a wireless communication device while the wireless communication device operates in a disconnected mode. A data connection between the wireless communication device and a radio-access network part of the cellular network is not maintained while the wireless communication device operates in the disconnected mode. The request message may be provided while the wireless communication device operates in the disconnected mode, or may be provided while the wireless communication device operates in a connected mode.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a cellular network and a UE that is connectable to the cellular network according to various examples.

FIG. 2 schematically illustrates a connected mode and multiple disconnected modes in which the UE that is connectable to the cellular network can operate according to various examples.

FIG. 3 schematically illustrates a discontinuous reception operation of the UE according to various examples.

FIG. 4 schematically illustrates transmissions of downlink P-RS for positioning of the UE according to various examples.

FIG. 5 schematically illustrates a base station according to various examples.

FIG. 6 schematically illustrates the UE according to various examples.

FIG. 7 schematically illustrates a position control node according to various examples.

FIG. 8 is a flowchart of a method according to various examples.

FIG. 9 is a flowchart of a method according to various examples.

FIG. 10 is a flowchart of a method according to various examples.

FIG. 11 is a signaling diagram according to various examples.

FIG. 12 is a signaling diagram according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the invention will be described in detail with reference to the accompanying drawings. It is to be understood that the following description of examples is not to be taken in a limiting sense. The scope of the invention is not intended to be limited by the examples described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques which facilitate positioning of UEs are described. Positioning allows determining the geographic position and/or velocity of the UE based on measuring the received UL and/or DL P-RSs. Location/Position estimates of the UE may be requested by and reported to a client (e.g., an application) associated with the UE, or by a client within or attached to a core network of a cellular NW. The location estimates may be reported in standard formats, such as those for cell-based or geographical co-ordinates, together with estimated errors (uncertainty) of the position and velocity of the UE and, if available, the positioning method (or the list of the methods) used to obtain the position estimate.

There are many different possible use cases for location estimates. The positioning estimates may be used internally by communication systems, such as 3GPP Long Term Evolution (LTE) cellular NWs or 5G New Radio (NR) cellular NWs, by value-added network services, by the UE itself or through the network, and by “third party” services. The functions may also be used by an emergency service, but the location service is not exclusively for emergencies.

The techniques disclosed herein can be generally applied to various kinds and types of cellular NWs. However, hereinafter, reference will be made to 3GPP specified cellular NWs, for illustrative purposes. Specifically, reference will be made to 3GPP NR cellular NWs.

The techniques disclosed herein disclose aspects with respect enabling positioning of a UE at low latency and low power consumption. Furthermore, the techniques disclosed herein facilitate implementing positioning of a UE while the UE operates in a disconnected mode. While the UE operates in the disconnected mode, a data connection between the UE and the radio access network part of the cellular NW may not be maintained. Examples of the disconnected mode include the 3GPP RRC_INACTIVE, as well as 3GPP RRC_IDLE mode. This facilitates a low power consumption at the UE, despite being able to position the UE.

The techniques described herein generally rely on transmissions of P-RSs. Various implementations of P-RSs are conceivable. For example, P-RSs may be transmitted in the DL (e.g., 3GPP PRS) or in the UL (e.g., 3GPP SRS). According to the disclosure, DL-based positioning and/or UL-based positioning can be used. For DL positioning: The DL P-RSs are transmitted by multiple BSs or transmission and reception points, TRPs, (e.g., gNBs for 3GPP NR) and can be received by a target UE to be positioned. On the other hand, for the UL positioning, the UL RSs—e.g., SRSs—are transmitted by the target UE to be positioned and can be received by multiple BSs or TRPs.

The P-RS can be broadcasted. Cell-specific P-RS can be employed. Resources can be allocated to a transmission of P-RS that support multiple beams. For instance, P-RSs could be arranged in an interleaved pattern (e.g. comb-N pattern) multiplexed with different transmit-receive points (TRPs) of a BS. The P-RS from a TRP is transmitted in every Nth sub-carrier and be interleaved with the P-RS from other TRPs. Here, a UE can perform positioning measurements on multiple TRPs simultaneously.

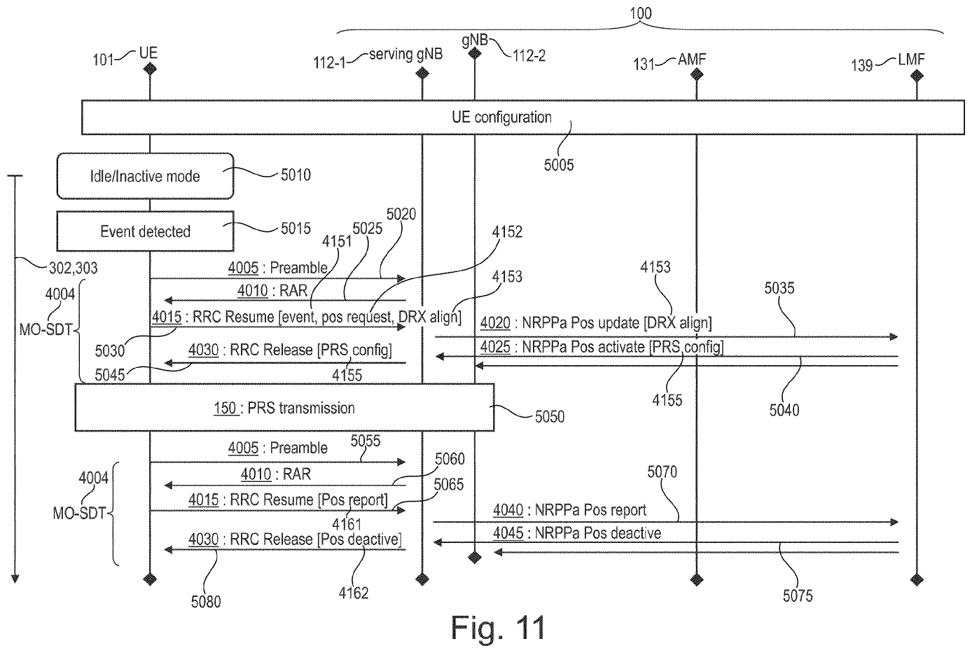

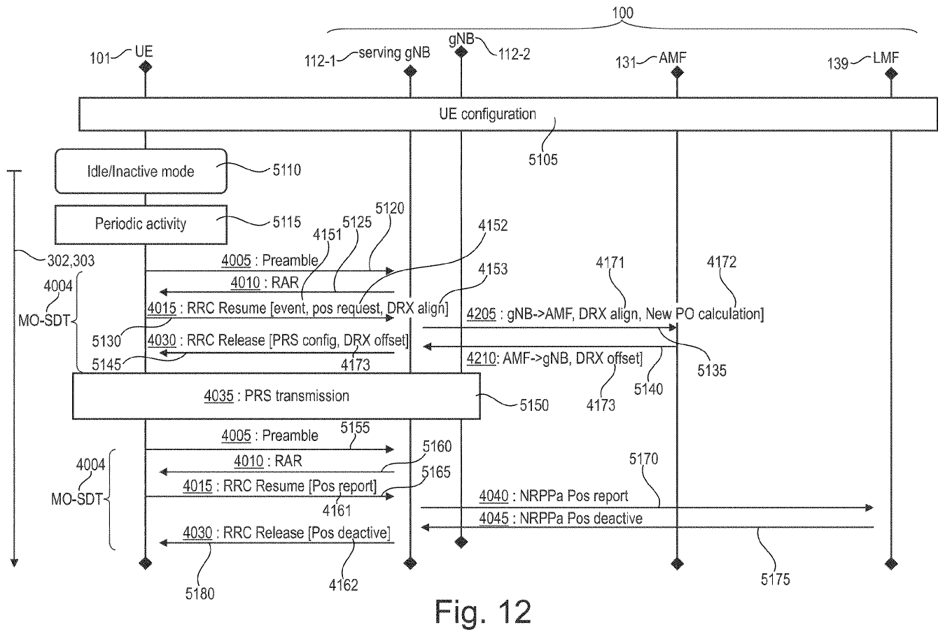

According to various examples disclosed herein, always-on/periodic P-RS can be used for the positioning. Another example would be on-demand transmission of P-RSs. Here, a UE can request the transmission of P-RSs, e.g., in case there is no suitable periodic transmission of P-RSs (this will be later on explained in detail with respect to FIG. 11:5030 and FIG. 12:5130). Such request can be UE-specific. The UE and the BS can be configured such that the BS transmits, upon receiving a respective request message, on-demand P-RSs for the requesting UE. The BS can inform a location control node regarding the on-demand transmission of P-RSs, e.g., in advance of transmitting the P-RSs (this will be explained later in connection with FIG. 11:5035). The location control node can then select and configure the BS(s) and the UE with relevant information, e.g., pertaining to the timing of the transmission of the on-demand P-RSs.

According to various examples described herein, transmissions of the P-RSs may be implemented on a wireless link on which also transmission of further signals is implemented. In particular, the further signals may encode, e.g., control messages or data/payload messages. The wireless link may operate according to a transmission protocol. For example, the transmission protocol may employ Orthogonal Frequency Division Multiplex (OFDM) modulation. Here, a carrier comprises multiple subcarriers and one or more associated time-frequency resource grids are defined. A transmission of one or more P-RSs can be allocated to time-frequency resources of the time-frequency resource grid. For example, the transmission protocol may be associated with a RAN part of a cellular NW; here, the BSs can be implemented by BSs of the RAN.

The positioning method used herein may generally comprise time difference of arrival (TDOA), observed TDOA (OTDOA), round trip-time (RTT), received reference signal power (RSRP) path loss measurements, angle of departure (AoD), or angle of arrival (AoA). Such positioning methods can be implemented based on DL and/or UL P-RSs.

It would be possible that the logic for implementing positioning—i.e., determining the location estimate based on one or more positioning measurement-partly or fully resides at the UE to be positioned, and/or partly or fully resides at a location control node, e.g., implemented by a 3GPP Location Management Function (LMF). For example, it would be possible that the UE reports raw measurement data associated with the one or more receive properties of the P-RSs to the location control node—e.g., in a respective positioning measurement report- and that the location estimate is then determined at the location control node. It would also be possible that at least a part of the processing of the raw measurement data is implemented at the UE; the UE can then provide the positioning measurement report that is indicative of a result of such (pre-) processing.

Hereinafter, techniques are disclosed which facilitate positioning a UE while the UE operates in a disconnected mode. The disconnected mode may restrict connectivity, e.g., in terms of when the UE can receive data and/or in terms of what signals the UE can receive. The disconnected mode can generally enable a UE to shut down partly or fully one or more components of its wireless interface. When a UE operates in the disconnected mode, it is possible that the cellular NW discards certain information associated with the UE, e.g., certain information of the UE context, etc. It would be possible that a UE-specific data connection on the wireless link between the cellular NW and the UE is released.

The disconnected mode can be associated with a discontinuous reception (DRX) operation of the UE. Typically, the configuration of the DRX operation is cell-based and/or UE-specific. The DRX operation can be based on a DRX cycle timing indicated by the cellular NW. The DRX operation can be in accordance with paging occasions (POs). The DRX operation can specify how the UE transitions its wireless interface between an inactive state and an active state. When in the inactive state, the wireless interface may be unfit to receive data. The respective active durationduring which the receiver circuit operates in the active state—can include the paging occasion. The UE monitors for paging signals during the PO. Using the inactive state in-between POs reduces the cost of idle channel listening and reduces the power consumption at the UE.

Various techniques are based on the finding that, according to reference implementations, the transmissions of P-RSs are typically not time-aligned with the active durations of the DRX of the DRX operation of the UE or at least, the transmission of P-RS and the active durations of the DRX are configured independently. This can result in a scenario in which the UE, operating according to reference implementations, performs a power-hungry transition between the inactive state and the active state to be able to participate in the positioning, e.g., to transmit UL P-RS or to monitor for DL P-RS for performing positioning measurements. For instance, according to reference implementations, the UE may be forced to transition its wireless interface into the active state to be able to perform a positioning measurement based on a transmission of periodic P-RS, half-way in between two adjacent POs. Hereinafter, techniques are disclosed to mitigate such issues.

According to various examples, it is possible to configure the DRX operation of the UE so that time-alignment of POs with one or more transmissions of UL and/or DL P-RS becomes possible. Alternatively or additionally, time-alignment of POs with UL reporting on positioning measurements would be possible

Such configuring of the DRX operation of the UE can take various forms. For example, it would be possible that a time duration is indicated to the UE during which the UE—while using DRX, i.e., while alternatingly transitioning its receiver between an inactive and an active stateshould expect downlink signals to arrive. Such time durations may be indicated relative to the DRX cycle. It would be possible that such time durations are indicated relative to a timing of a paging occasion. More specifically, a time duration can be indicated to the UE during which the UE should expect DL P-RS. This can correspond to a measurement occasion. Knowledge of the measurement occasion impacts a DRX operation at the UE, because the UE will then attempt to activate its receiver—i.e., transition to the active state-prior to the measurement occasion to be able to perform a positioning measurement by monitoring for the DL P-RS. The UE may keep the receiver activated for an extended time duration, e.g., after a paging occasion, to perform the positioning measurement. According to various examples, it would be possible that such measurement occasion is indicated to the UE by a location server that thereby configures the DRX operation of the UE. Another example of configuring the DRX operation of the UE would be to indicate, to the UE, certain time durations during which the UE—while using DRX, i.e., while alternatingly transitioning its receiver between an inactive and an active state—is to transmit UL P-RS. Yet another example of configuring the DRX operation would be to indicate to the UE—while using DRX, i.e., while alternatingly transitioning its receiver between an inactive and an active state-a timing of paging signals. In other words, it would be possible that the timing of the paging occasions is indicated to the UE. During the paging occasion the UE—while using DRX, i.e., while alternatingly transitioning its receiver between an inactive and an active state—is requested to monitor for paging signals that are or may be transmitted by the cellular NW. For instance, the timing of the paging occasions can be offset with respect to a reference timing that is determined based on an identity of the UE. Furthermore, it would be possible that the actual paging occasions are not only determined based on the reference timing and the time offset, but also the DRX cycle. For instance, the DRX cycle may have a longer periodicity compared to the occurrences of the paging occasions determined based on the reference timing. For instance, such timing of the paging occasions may be set by a base station of the cellular NW. Yet another example of configuring the DRX operation of the UE would be to indicate to the UE certain time durations during which the UE—while using DRX, i.e., while alternatingly transitioning its receiver between an inactive and an active state—is to report on positioning measurements.

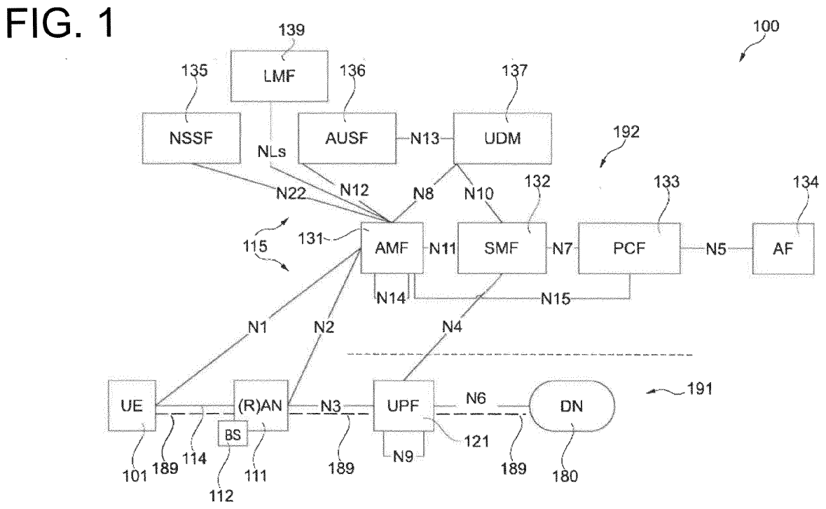

FIG. 1 schematically illustrates a cellular NW 100. The example of FIG. 1 illustrates the cellular NW 100 according to the 3GPP 5G architecture. Details of the 3GPP 5G architecture are described in 3GPP TS 23.501, version 1.3.0 (2017-09). While FIG. 1 and further parts of the following description illustrate techniques in the 3GPP 5G framework of a cellular NW, similar techniques may be readily applied to other communication networks. Examples include e.g., an IEEE Wi-Fi technology.

In the scenario of FIG. 1, a UE 101 is connectable to the cellular NW 100. For example, the UE 101 may be one of the following: a cellular phone; a smart phone; an IOT device; a MTC device; a sensor; an actuator; etc.

The UE 101 is connectable to the network 100 via a RAN 111, typically formed by one or more BSs 112 (only a single BS 112 is illustrated in FIG. 1 for the sake of simplicity; for instance the BS 112 can implement a 3GPP gNB or eNB). A wireless link 114 is established between the RAN 111—specifically between one or more of the BSs 112 of the RAN 111—and the UE 101. The wireless link 114 is defined by one or more OFDM carriers.

The RAN 111 is connected to a core network (CN) 115. The CN 115 includes a user plane (UP) 191 and a control plane (CP) 192. Application data is typically routed via the UP 191. For this, there is provided a UP function (UPF) 121. The UPF 121 may implement router functionality. Application data may pass through one or more UPFs 121. In the scenario of FIG. 1, the UPF 121 acts as a gateway towards a data network 180, e.g., the Internet or a Local Area Network. Application data can be communicated between the UE 101 and one or more servers on the data network 180. The cellular NW 100 also includes an Access and Mobility Management Function (AMF) 131 implementing a mobility control node; a Session Management Function (SMF) 132; a Policy Control Function (PCF) 133; an Application Function (AF) 134; a Network Slice Selection Function (NSSF) 135; an Authentication Server Function (AUSF) 136; a Unified Data Management (UDM) 137; and a Location Management Function (LMF) 139 implementing a location control node. FIG. 1 also illustrates the protocol reference points N1-N22 between these nodes.

The AMF 131—implementing a mobility control node—provides one or more of the following functionalities: registration management; non-access stratum (NAS) termination; connection management; reachability management; mobility management; access authentication; and access authorization. A data connection 189 is established by the AMF 131 if the respective UE 101 operates in a connected mode. POs can be managed by the AMF 131, e.g., a time offset may be applied with respect to reference timing of paging occasions, the reference timing being defined by an identity associated with the respective UE 101.

The SMF 132 provides one or more of the following functionalities: session management including session establishment, modify and release, including bearer set up of UP bearers between the RAN 111 and the UPF 121; selection and control of UPFs; configuring of traffic steering; roaming functionality; termination of at least parts of NAS messages; etc. As such, the AMF 131 and the SMF 132 both implement CP mobility management needed to support a moving UE. The data connection 189 is established between the UE 101 via the RAN 111 and the data plane 191 of the CN 115 and towards the data network (DN) 180. For example, a connection with the Internet or another packet data network can be established. To establish the data connection 189, it is possible that the respective UE 101 performs a random access (RACH) procedure, e.g., in response to reception of a paging indicator or paging message and, optionally, a preceding wake up signal. A server of the DN 180 may host a service for which payload data is communicated via the data connection 189. The data connection 189 may include one or more bearers such as a dedicated bearer or a default bearer. The data connection 189 may be defined on the RRC layer, e.g., generally Layer 3 of the Operating Systems Interconnection (OSI) model of Layer 2. The data connection 189 can carry application data.

The LMF 139 handles location service requests. This may include transferring assistance data to the target UE 101 to be positioned to assist with UE-based and/or UE-assisted positioning and/or may include positioning of the target UE. See 3GPP TS 38.305 V17.0.0 (2022-03), section 5.1. For DL positioning using PRSs, the LMF 139 may instigate positioning using a PP with the UE 101—e.g. to obtain a location estimate or positioning measurements or to transfer location assistance data to the UE 101.

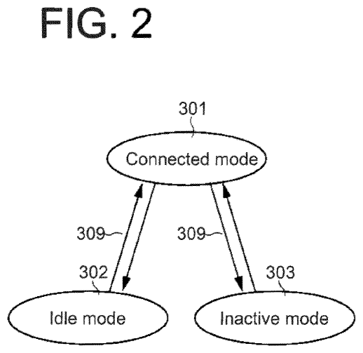

FIG. 2 schematically illustrates aspects with respect to multiple operational modes 301-303 in which a UE can operate.

The data connection 189 is established in the connected mode 301. In particular, a RANpart of the data connection 189 is established in the connected mode 301. Data can be communicated between the UE 101 and the BS 112 using a physical downlink shared channel (PDSCH), physical downlink control channel (PDCCH), physical uplink shared channel (PUSCH), physical uplink control channel (PUCCH). RRC control messages can be communicated on PDSCH and/or PUSCH. Positioning measurement reports can be communicated on the PUSCH. It is possible to use connected-mode DRX. The connected mode 301 can be implemented by the 3GPP RRC_CONNECT.

FIG. 2 also illustrates two disconnected modes 302, 303. A first disconnected mode is the idle mode 302, e.g., implemented by 3GPP RRC_IDLE. A second disconnected mode is the inactive mode 303, e.g., implemented by 3GPP RRC_INACTIVE. Typically, the inactive mode 303 is transparent to the CN 115, while the idle mode 302 may be signaled to the CN 115. Thus, the UE context 459 may be maintained at the CN 115 when the UE 101 operates in the inactive mode 303.

FIG. 2 also illustrates aspects with respect to the transitions 309 between the various modes 301-303. For instance, to trigger the transition 309 from the connected mode 301 to one of the disconnected modes 302-303, a connection deactivation message can be communicated, e.g., using RRC control signaling on the PDSCH or PUSCH. This may be a connection inactivate control message for the transition 309 to the inactive mode 303; or a connection release message for the transition 309 to the idle mode 302. The connection release message triggers release of the data connection 189.

Such messages can include an information element that carries additional data. For instance, information of a PP can be included in such information elements.

The transition 309 from the idle mode 302 or the inactive mode 303 to the connected mode 301 includes a RACH procedure. The RACH procedure may be triggered by paging signals, e.g., a paging indicator or a paging early indicator (PEI) on PDCCH and a paging message on PDSCH. In the inactive mode 303, paging can be triggered by the RAN; while in the idle mode 302 the paging is triggered by the CN. The RACH procedure can include an UL transmission of a RACH preamble, a DL random access response message, an UL RRC resume message and, e.g., a DL release or connection establishment message.

Sometimes, the random-access procedure may also be used to transmit uplink data from the UE to the cellular NW. UE-originating (mobile originating, MO) UL data may be communicated. The random-access procedure could also be used to provide DL data to the UE, i.e., UE-terminating (mobile terminating, MT) DL data. An SDT protocol can be employed to accommodate data, e.g., and a Random Access Message 3 or 4 (RRC Resume message and RRC Release message). In such a scenario, it is not required that subsequently the data connection is established; rather, the UE can, upon providing the data to the cellular NW, continue to operate either in the idle mode 302 of the inactive mode 303.

The disconnected modes 302, 303 are typically associated with DRX operation of the UE 101.

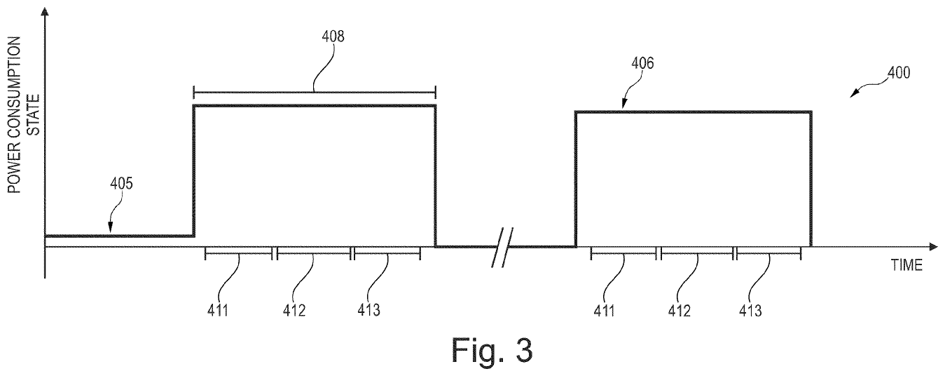

FIG. 3 schematically illustrates aspects with respect to DRX operation 400 of the UE 101. For example, the DRX operation 400 illustrated in FIG. 3 may be associated with a disconnected mode such as the idle mode 302 of the inactive mode 303 as discussed above in connection with FIG. 2. The DRX operation 400 of the UE 101 is characterized by various parameters. Techniques are disclosed that pertain to the cellular NW configuring the DRX operation 400 of the UE. Configuring the DRX operation 400 of the UE 101 means that one or more of these parameters are set at the UE based on information provided from the cellular NW.

The DRX operation 400 defines a repetitive transition of the wireless interface of the UE 101 back-and-forth between an inactive state 405 and an active state 406. The respective active duration 408 of the active state 406 is illustrated in FIG. 3. The UE is unfit to transmit or receive data when the wireless interface operates in the inactive state 405.

According to various examples, the DRX operation 400 of the UE 101 is configured so that during the active duration 408 the UE monitors for paging signals during a respective PO 411, performs a positioning measurement during a respective position measurement occasion (PMO) 412 and/or implements reporting on the positioning measurement during a respective position reporting occasion (PRO) 413.

During the PO 411 paging signals may or may not be transmitted by the cellular NW 100, depending on whether the UE 101 is paged or not.

The PMO 412 equates to a transmission of one or more P-RS.

The PRO 413 may be associated with an opportunity for the UE to provide UL data includeing positioning measurement report(s) to the cellular NW 100. For instance, a SDT may be used. In the illustrated example, the DRX operation 400 of the UE 101 is configured so that the active duration 408 includes, in sequence, the PO 411, the PMO 412, as well as the PRO 413. As a general rule, it would also be possible to spread out occasions across multiple active durations 408. In other words, while FIG. 3 schematically illustrates a scenario in which the PO 411, the PMO 412 and the PRO 413 are all adjacent to each other in the time domain, there may be a time gap in between two or more of these occasions. It would be possible that the DRX operation of the UE 101 is configured to transition into the inactive state 405 between, e.g., the PRO 413 and the PMO 412, to give just one example. By time aligning these occasions within a single active duration 408, power-efficient operation of the UE 101 is supported, because the switching back and forth between the inactive state 405 and the active state 406 can be reduced.

There are various options available for the cellular NW to configure the DRX operation 400. Some of these options are summarized below in TAB. 1.

TABLE 1
Various options for providing information elements to the UE 101 that enable
the UE 101 to configure the DRX operation 400. Typically, the concrete
timings for transitioning from the inactive state to the active state (or
vice versa) are UE-implementation details that are derived from information
elements as presented above. The reason is that, e.g., the time required
for transitioning from the active state to the inactive state or vice versa
depends on the receiver hardware of the UE. Accordingly, to accommodate
for a sufficient lead time to transition the receiver hardware from the
inactive state to the active state prior to a time span during which the
UE is expected to monitor for signals can be up to UE implementation.

| | INFORMATION | |
|---|---|---|
| | ELEMENT | EXAMPLE DETAILS |
| I | DRX cycle | To configure the DRX operation 400, the cellular NW may |
| | | indicate to the UE a DRX cycle time. The DRX cycle time |
| | | may specify periodic time durations during which the PO |
| | | 411 and/or the PMO 412 and/or the PRO 413 are arranged. |
| | | It would also be possible to signal to the UE |
| | | multiple DRX cycle times, e.g., one for the PO 411 and |
| | | one for the PMO 412 and/or the PRO 413. |
| II | Timing | The cellular NW can configure the DRX operation by |
| | information | specifying a start time and a stop time of the PO 411 |
| | for | and/or the PMO 412 and/or the PRO 413. |
| | occasion | In some scenarios, the timing information for the PMO 412 |
| | | and/or for the PRO 413 may be relatively defined with |
| | | respect to a (e.g., predetermined) timing of the PO 411. |
| | | For instance, the timing of the PO 411 may be determined |
| | | depending on an identity of the UE, e.g., using a modulus- |
| | | operation for the IMSI, and then it would be possible to |
| | | specify a time offset - e.g., in terms of resource blocks |
| | | or timeslots - for the PMO 412 and/or the PRO 413. |
| | | The timing information for the PMO 412 may be provided |
| | | by specifying a transmission timing of P-RSs. |

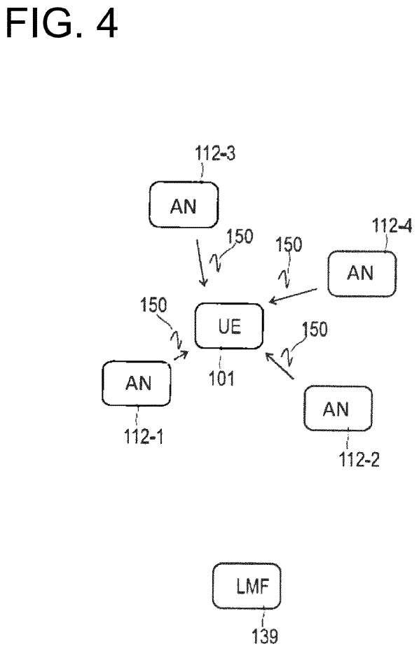

FIG. 4 schematically illustrates aspects with respect to DL positioning for a UE 101 (sometimes referred to as target UE) to be positioned. While FIG. 4 illustrates DL positioning, as a general rule, the techniques disclosed herein may also be applicable for UL positioning.

Multiple BSs (labeled as access nodes, ANs in FIGS. 4) 112-1-112-4 transmit DL P-RSs 150 (as an example of P-RS) and the UE 101 receives the P-RSs 150, e.g., during a PMO 412. Then, the UE 101 can participate in positioning, report positioning measurements—e.g., to the LMF 139 via one of the BSs—, determine a location estimate, etc.

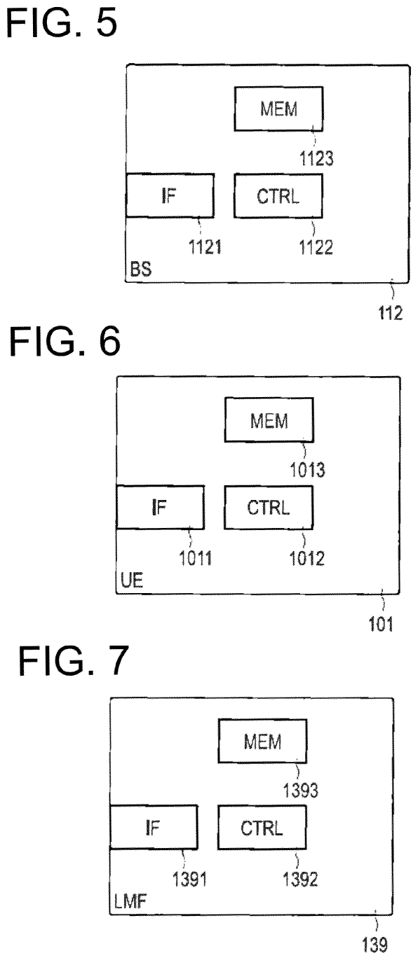

FIG. 5 schematically illustrates the BS 112. For example, the BSs 112-1-112-4 could be configured accordingly. The BS 112 includes a wireless communication interface 1121 (simply interface hereinafter). For example, the interface 1121 may include an analog front end and a digital front end. The BS 112 further includes control circuitry 1122, e.g., implemented by means of one or more processors and software. For example, program code to be executed by the control circuitry 1122 may be stored in a non-volatile memory 1123. In the various examples disclosed herein, various functionality may be implemented by the control circuitry 1122, e.g.: transmitting P-RSs; receiving SRS; configuring DRX operation of the UEs, e.g., defining a time offset of the PO with respect to a reference timing; assigning a temporary identity to the UE; etc.

The BS 112 may establish one or more logical communication interfaces via the interface 1121. The BS 112 may implement communication via the logical communication interface with the UE 101 and/or one or more nodes of the core network, e.g., the LMF 139.

The BS 112 may also communicate with the LMF 139. For example, the BS may provide information regarding the DRX operation of a UE 101 to the LMF 139, e.g., timing of PO or DRX cycle timing information, receive positioning requests from the LMF 139 and forward the positioning requests to the UE 101. The BS 112 may receive assistance information from the LMF 139. Communication/signaling between the BS 112 and the LMF 139 may be implemented according to 3GPP TS 38.305 version 17.0.0, Section 6.5: Signaling between an LMF and NG-RAN node.

FIG. 6 schematically illustrates the UE 101. The UE 101 includes a wireless interface 1011. For example, the interface 1011 may include an analog front end and a digital front end. The UE 101 further includes control circuitry 1012, e.g., implemented by means of one or more processors and software. The control circuitry 1012 may also be at least partly implemented in hardware. For example, program code to be executed by the control circuitry 1012 may be stored in a non-volatile memory 1013. In the various examples disclosed herein, various functionality may be implemented by the control circuitry 1012, e.g.: providing a request for positioning of the UE 101; transmitting or attempting to receive (monitor for) P-RS; performing a positioning measurement, e.g., including determining TOAs of the P-RSs, determining TDOA, multilateration and/or multiangulation for the case of UE-based positioning; provide a positioning measurement report, e.g., to the LMF 139, performing DRX operation; operating in a connected or a disconnected mode; provide information regarding DRX operation to the LMF 139; etc. The UE 101 may communicate with the LMF 139 according to 3GPP TS 38.305 version 17.0.0, Section 6.4: Signaling between an LMF and UE.

FIG. 7 schematically illustrates a location control node implemented, in the example of FIG. 7, by the LMF 139. The LMF 139 includes an interface 1391 for communicating with other nodes of the CN 115 or with the RAN 111 of the cellular NW 100. The LMF 139 further includes control circuitry 1392, e.g., implemented by means of one or more processors and software. For example, program code to be executed by the control circuitry 1392 may be stored in a non-volatile memory 1393. In the various examples disclosed herein, various functionality may be implemented by the control circuitry 1392, e.g.: configuring DRX operation at a UE, e.g., by providing a timing information for P-RS transmission in the UL or DL to the UE; obtaining a request for positioning of a UE; configuring a P-RS transmission; setting a transmission timing of transmissions of P-RSs; etc.,

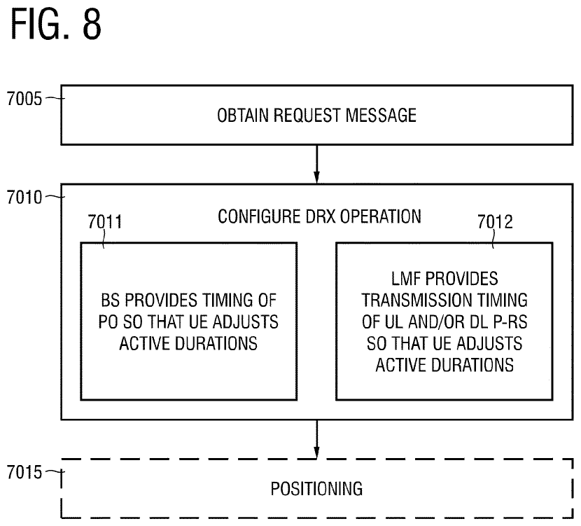

FIG. 8 is a flowchart of a method according to various examples. For instance, the method of FIG. 8 may be executed by a location control node such as the LMF 139. Alternatively or additionally, the method of FIG. 8 may be executed by a BS such as the BS 112 or a mobility control node such as the AMF 131. For instance, the method of FIG. 8 may be executed by the control circuitry 1122 of the BS 112 upon loading and executing program code from the memory 1123. The method of FIG. 8 may be executed by the control circuitry 1392 upon loading and executing program code from the memory 1393.

Optional boxes are illustrated using dashed lines.

The method of FIG. 8 facilitates positioning of a UE, while the UE operates in a disconnected mode (cf. FIG. 2: idle mode 302 or inactive mode 303). The UE is connectable to the cellular NW. FIG. 8 specifically relates to configuring one or more transmissions of P-RSs so that the UE can be positioned based on the P-RSs while the UE operates in the disconnected mode.

At box 7005, a request message for positioning of the UE is received. The positioning of the UE is to be executed while the UE operates in a disconnected mode (cf. FIG. 2: idle mode 302 or in active mode 303). The request message may be obtained from the UE or from a RAN node, e.g., a BS.

In some scenarios, the request message may be obtained while the UE operates in the disconnected mode. In other scenarios, it would also be possible that the request message is obtained from the UE while the UE operates in the connected mode. It would also be possible that the request message is obtained by the UE transitions from operating in the connected mode to operating in the disconnected mode, or vice versa.

For instance, the request message may be an RRC Connection Release message that triggers the transition from the connected mode to the disconnected mode.

For instance, the request message may be obtained using an SDT as part of a random-access procedure of the UE. An MO-SDT may be employed.

As a general rule, the request message can be indicative of positioning of the UE using on-demand P-RS or periodic P-RS. For instance, the request message could carry a respective indicator that is indicative of whether the UE requests positioning based on the on-demand P-RS or the periodic P-RS.

Upon obtaining the request message at box 7005, at box 7010, DRX operation of the UE is configured. This is done to enable one or more transmissions of P-RS for positioning of the UE, while the UE operates in the disconnected mode.

Configuring the DRX operation of the UE at box 7010 can include determining one or more respective parameters that impact the DRX operation 400 at the UE, as will be described below in connection with TAB. 2, and providing a respective configuration message that is indicative of the determined parameters to the UE.

Two scenarios for configuring the DRX operation at box 7010 are illustrated below in connection with TAB. 2.

TABLE 2
Various options for configuring the DRX operation of a UE. The options can facilitate time-
alignment of measurement occasions with POs, either by shifting, in time domain, the measurement
occasions or by shifting the POs. By appropriately configuring the DRX operation of the UE,
the time the UE can operate the wireless interface in the inactive state can be maximized.
Thereby, the power consumption at the UE can be reduced. Switching between the inactive and
active states can be reduced. Transitions back to the connected mode can be avoided.

| | BRIEF | |
|---|---|---|
| SCENARIO | DESCRIPTION | DETAILED DESCRIPTION |
| I | Configure PO | According to examples, it is possible that configuring the DRX |
| | itimng - box 7011 | operation of the UE includes configuring a timing of POs of the |
| | | DRX operation. Specifically, the PO timing can be configured |
| | | in accordance with a transmission timing of the one or more |
| | | transmissions of the one or more P-RS. |
| | | Such a scenario is helpful where the transmission timing is pre- |
| | | determined by the core network part of the cellular NW. In other |
| | | words, the PMO for monitoring P-RS can be predetermined by, |
| | | e.g., a location control node (cf. LMF 139). Such (re-)configuration |
| | | of the timing of the PO can then be transparent to the |
| | | LMF. Such a scenario is, in particular, helpful where the configuration |
| | | of the DRX operation at box 7010 is executed by a BS |
| | | or a mobility control node such as the AMF. Then, the LMF |
| | | needs not to be involved which simplifies the core-network |
| | | operation. Also, for periodic P-RSs, reconfiguration of other UEs |
| | | that monitor for these P-RSs and/or indication of the changes |
| | | in an information block broadcasted in the respective cell may |
| | | not be required. |
| | | For instance, it would be possible to configure the timing of the |
| | | PO for the target UE by configuring a time offset of the POs |
| | | with respect to a predetermined reference timing. Such |
| | | predetermined reference time can depend on the identity of the UE. |
| | | Conventionally, the POs are defined by the international mobile |
| | | subscribe identity (IMSI) of the UE, using a modulus calculation. |
| | | It would be possible to assign a temporary identity that |
| | | differs from the IMSI of the UE, to thereby specify the time |
| | | offset. Alternatively, it would also be possible to specify the time |
| | | offset in absolute time increments. |
| II | Configure MO | In some scenarios, it would be possible that configuring the |
| | timing - box 7012 | DRX operation of the UE includes configuring a transmission |
| | | timing of one or more transmissions of one or more P-RS, in |
| | | accordance with a timing of POs of the DRX operation. |
| | | This also impacts the DRX operation of the UE, because the |
| | | UE is expected to monitor for the DL P-RS and/or transmit UL |
| | | P-RS in accordance with such timing; this means that the UE |
| | | is expected to transition its receiver (or transmitter) to the active |
| | | state prior to the time duration during which DL P-RS are |
| | | expected or prior to the time duration during which the UE is |
| | | expected to transmit UL P-RS. |
| | | Such a scenario may be helpful where the POs are predetermined, |
| | | e.g., by the RAN part of the cellular NW; then, the |
| | | transmission timing of the transmission of the one or more reference |
| | | signals - in other words, the PMOs - can be aligned with the |
| | | predetermined POs. |
| | | Such a scenario is helpful where the location control node |
| | | configures the DRX operation of the UE at box 7010. In such a |
| | | case, the location control node can obtain, e.g., from the UE or |
| | | the RAN part of the cellular NW, a message that is indicative of |
| | | a timing of the POs. |
| | | It is possible that the location control node informs the BS |
| | | serving the UE regarding this configuration. For instance, the |
| | | location control node can provide an indication of the transmission |
| | | timing of the one or more transmissions of one or more P-RS |
| | | to the BS. The location control node can inform the BS |
| | | regarding the PMO and/or PRO configured at the UE. For example, it |
| | | is possible that the DRX operation of the UEs configured by the |
| | | location control node. In such a scenario, the location control |
| | | node can inform the BS that the DRX operation has been |
| | | configured. For instance, the BS may be informed that the UE will |
| | | switch the receiver on earlier (i.e., transition the receiver to the |
| | | active state), e.g., ahead of a PO. The BS may be informed that |
| | | the UE will, in a given DRX cycle, switch the receiver on in |
| | | addition to the PO, e.g., transition the receiver to teh active state |
| | | for a PMO or a PRO. If, on the other hand, the configuration of |
| | | the DRX results in, e.g., an extended time duration during |
| | | which the receiver of the UE operates in the active state after a |
| | | PO, then the BS may not be required to have such information. |
| | | The timing of the POs can then remain unaltered; e.g., |
| | | the configuration of the DRX operation at box 7010 may be |
| | | transparent to the RAN part of the cellular NW. |
| | | Such a scenario may have advantages where a UE is to be |
| | | typically paged in a comparatively large tracking area; then, |
| | | instead of reconfiguring the timing of the PO for multiple BSs |
| | | being part of the tracking area, it can be more convenient to |
| | | adjust the timing of the PMO. |
| | | Furthermore, such flexible configuration of the PMO may be |
| | | possible where UE-specific P-RSs are used. Such a flexible |
| | | configuration of the PMOs may be possible where on-demand |
| | | P-RSs are used. |

At box 7015 it would then be optionally possible to participate in the positioning procedure. For instance, one or more transmissions of P-RS may be triggered or executed, while the UE operates in the disconnected mode. For instance, positioning measurements received from the UE may be evaluated, while the UE operates in the disconnected mode. For instance, positioning measurements received from the UE may be forwarded to a location control node. A position estimate of the UE may be provided to an application that has requested the positioning estimate.

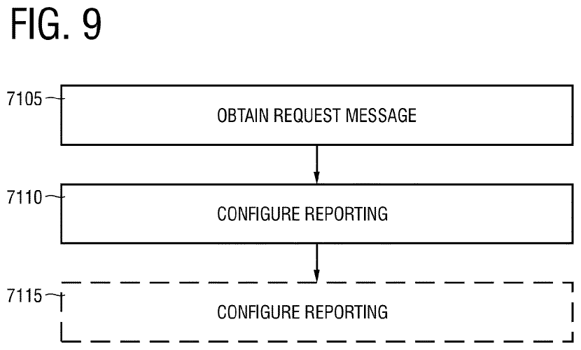

FIG. 9 is a flowchart of a method according to various examples. For instance, the method of FIG. 9 may be executed by a location control node such as the LMF 139. Alternatively or additionally, the method of FIG. 9 may be executed by a BS such as the BS 112 or a mobility control node such as the AMF 131. For instance, the method of FIG. 9 may be executed by the control circuitry 1122 of the BS 112 upon loading and executing program code from the memory 1123. The method of FIG. 9 may be executed by the control circuitry 1392 upon loading and executing program code from the memory 1393.

Optional boxes are illustrated using dashed lines.

The method of FIG. 9 facilitates positioning of a UE, while the UE operates in a disconnected mode. The UE is connectable to the cellular NW. FIG. 9 specifically relates to configuring reporting of positioning measurements while a UE operates in the disconnected mode.

In the scenario of FIG. 9, DL P-RS are used, e.g., PRS.

Box 7105 corresponds to box 7005 of the method of FIG. 8.

At box 7110, upon obtaining the request message, an UL reporting schedule for positioning measurements is configured.

As a general rule, the UL reporting schedule may define circumstances when the UE is to provide a positioning measurement report. The UL reporting schedule may specify a timing for providing positioning measurement reports. The UL reporting schedule may specify time-frequency resources that are to be used for providing positioning measurement reports.

Box 7110 can include determining the UL reporting schedule and providing a respective configuration message indicative of the determined UL reporting schedule to the UE.

The UL reporting schedule can be determined depending on the transmission timing of one or more transmissions of one or more PRS for positioning (i.e., depending on the timing of PMOs) and/or a timing of POs of a DRX operation of the UE.

For instance, it would be possible to time-align PMOs with the PROs. Alternatively or additionally, it would be possible to time align POs with the PROs.

Such techniques facilitate implementing multiple tasks in a single active duration of the DRX operation at the UE (cf. FIG. 3). For instance, during a single active duration, the UE can implement, both, monitoring for paging signals during a POs, as well as reporting on a positioning measurement. This reduces the UE power consumption, because overall the time required to operate in the active state and the necessary transitions from the inactive state to the active state can be reduced. Also, latency for providing positioning measurement reports can be reduced.

In some examples, it would be possible that the UL reporting schedule that is configured at box 7110 defines an aggregation of multiple positioning measurements. For instance, it would be possible to collectively report multiple positioning measurements that are executed during a time duration comprising multiple subsequent POs. In other words, it would be possible that aggregated reporting is provided for multiple positioning measurements that spread out in time domain across a time duration that spans multiple POs of the UE. Typically, such time duration would cover multiple subsequent active durations of the DRX operation of the UE. By such techniques, the reporting control signaling overhead can be reduced. For instance, a single message may include multiple information elements associated with the different positioning measurements; thereby, header information can be reused for the multiple positioning measurements.

Sometimes, such aggregation may depend on one or more preconditions. In other words, such aggregation may be conditionally triggered. In some scenarios, UE-centric triggers are conceivable. In other words, the UE may determine, for certain PROs, whether to use or not to use aggregation. For instance, it would be possible that the UL reporting schedule defines the aggregation depending on multiple positioning measurements. For instance, depending on a quality of the positioning measurements and/or depending on a variability or change rate of the positioning measurements, aggregation may or may not be used. For instance, where high quality and slowly changing positioning measurements are observed, aggregation may be used. On the other hand, where the positioning measurements are indicative of a significant change of the UE location per time, aggregation may not be used; thereby reducing latency in the position estimation.

The reporting schedule can define PROs employing SDT protocol prior to the establishment of the data connection. This renders it unnecessary to establish the data connection for providing the positioning measurement report from the UE to the cellular NW.

Box 7115 corresponds to box 7015.

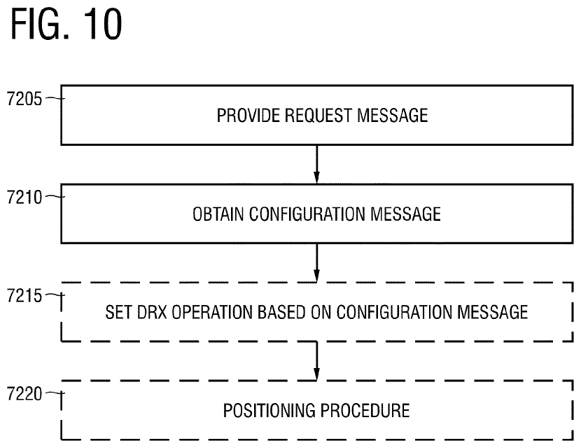

FIG. 10 is a flowchart of a method according to various examples. For instance, the method of FIG. 10 can be executed by a UE. The method of FIG. 10 may be executed by the control circuitry 1012 upon loading and executing program code from the memory 1013.

The method of FIG. 10 facilitates positioning of the UE while the UE operates in the disconnected mode. The UE is connectable to a cellular NW.

At box 7205, the UE provides a request message to the cellular NW. The request messages for positioning of the UE while the UE operates in a disconnected mode, e.g., an inactive mode or idle mode. The request message is provided at box 7205 while the UE operates in the disconnected mode. For instance, an SDT protocol may be employed for providing the request message at box 7205.

Providing the request message may be event-triggered (cf. FIG. 11: box 5015). Example events include a mobility event (e.g., detecting a new BS, detecting acceleration), an application request, etc. The request message may also be triggered periodically, e.g., in accordance with a positioning schedule that is predetermined (cf. FIG. 12: box 5115).

Box 7205 is interrelated with box 7005 and box 7105.

At box 7210, the UE can then obtain, from the cellular NW, a configuration message. The configuration message includes information that enables the UE to set-up its DRX operation. The configuration message can include information in accordance with TAB. 1. The configuration message can be indicative of a transmission timing of one or more transmissions of reference signals for positioning of the UE. In other words, the configuration message obtained at box 7210 can be indicative of one or more PMO for monitoring for downlink reference signals for positioning.

Such transmission timing can be time aligned with the timing of POs of a DRX operation of the UE. Respective techniques have been discussed above in connection with TAB. 2: example II, as well as FIG. 8. Also cf. FIG. 3.

The configuration message, alternatively or additionally, can be indicative of a time offset of POs of the DRX operation of the UE with respect to a predetermined reference timing. A temporary UE identity may be indicated. Respective techniques have been discussed above in connection with TAB. 2: example I; as well as FIG. 8, box 7010.

The configuration message can be, alternatively or additionally, it be indicative of an UL reporting schedule for reporting positioning measurements to the cellular NW. In other words, the configuration message can be indicative of PROs. For instance, the configuration message may specify respective UL time-frequency resources and/or a reporting periodicity. The configuration message may specify that the network expects respective positioning measurements as part of a SDT protocol to be transmitted by the UE. Respective techniques have been discussed above in connection with FIG. 9.

Based on such or other information, the UE can then set its DRX operation.

At box 7215, the UE can set the DRX operation (cf. FIG. 3). For instance, the UE can set the active durations of the DRX operation. For instance, the active durations can be aligned with the timing of the POs as indicated in box 7210; and/or aligned with the PMOs as indicated in box 7210. The active durations of the DRX operation can span a PO and/or PMO, as well as a PRO.

At box 7220, the UE can participate in the positioning. The UE may not need to establish a connected mode. The UE may remain in the disconnected mode. In case of DL positioning, the UE may attempt to receive DL P-RS, e.g., PRS, during one or more PMOs. The UE may provide positioning measurement reports to the cellular NW, during one or more PROs. In case of UL positioning, the UE may transmit UL P-RS.

FIG. 11 is a signaling diagram of communication between the UE 101 and the cellular NW 100. For instance, the methods according to FIG. 8, FIG. 9 in FIG. 10 can be implemented by the signaling of FIG. 11.

FIG. 11 corresponds to a scenario in accordance with TAB. 2: example II. More specifically, FIG. 11 corresponds to positioning of the UE using on-demand DL PRSs 150. One or more transmissions of the on-demand DL PRSs 150 can be requested by the UE, triggered by a respective event. Alternatively (not shown in the figure), one or more transmissions of the on-demand DL PRSs 150 can be requested, e.g., by the UE 101 or by an application node, e.g., in a DN, triggered by a respective event. In case of aperiodic/event triggered PRS transmission, the PRS transmission by the BS 112-1, 112-2 (labeled gNB in FIG. 11) is initiated by the LMF 139, but triggered by a UE-event such as movement, change of temperature, time, etc. According to the signaling of FIG. 11, the LMF 139 can assign and optionally configure a transmission timing of PRS transmissions to relevant BSs 112-1, 112-2, and associated PMOs at the UE 101. Theses PMOs are aligned with the timing of the POs. In order to make LMF 139 aware of UEs configuration of the DRX operation (e.g., timing of POs, or even active durations, etc.), the UE provides a report message to LMF 139 (cf. 5030, 5035), where the report message includes the identity of the UE, and/or its calculated DRX cycle/paging frame, i.e. in which subframe number it will wake up to monitor the PO. This report can be in a dedicated information element in the on-demand PRS request message. The report message may be communicated on a logical communication link between the UE 101 and the LMF 139. The report message may be communicated via the BS 112-1. LPP may or may not be used. The LMF 139 then assigns and configures a PRS pattern (i.e., a transmission timing for one or more transmissions of DL PRS) to relevant BSs 112-1, 112-2, and the UE 101. These aspects are now discussed in further detail with reference to FIG. 11

At 5005, the UE 101 is configured by the cellular NW 100 to transition into the disconnected mode, e.g., the idle mode 302 or the inactive mode 303. The respective configuration can also be notified to some nodes of the cellular NW 100, e.g., the AMF 131 (for inactive mode 303 the AMF 131 is not informed) and/or the LMF 139.

Optionally, at box 5005, positioning of the UE 101 may be preconfigured. For instance, a capability of the UE 101 to participate in the positioning when operating in the disconnected mode 302, 303 may be signaled from the UE 101 to the cellular NW 100 and it would be possible that, based on such indication, one or more parameters of the positioning are preconfigured, e.g., the particular positioning method to use, whether event-triggered positioning is possible, etc.

At box 5010, the UE 101 commences to operate in the disconnected mode 302, 303. This can include the respective DRX operation 400, e.g., employing a repetitive transitioning between inactive and active receiver states (cf. FIG. 3).

At box 5015, the UE 101 detects an event. The event is associated with positioning of the UE. For instance, the event can be a positioning request from an application executed by the UE 101. Then, the UE participates in a mobile originating small data transmission 4004 that employs a RACH procedure.

Specifically, a random-access preamble 4005 is transmitted by the UE 101 and received by the base station 112-1, at 5020. At 5025, the base station 112-1 responds with a Random Access Response (RAR) message 4010. Then, an RRC resume message 4015 is transmitted by the UE 101 to the base station 112-1, at 5030. The RRC resume message 4015 includes multiple information elements, specifically an indicator 4151 indicative of the event that is detected at box 5015, a positioning request 4152 for positioning of the UE 101, and an information element 4153 that is indicative of a request to align the transmission timing of the one or more transmissions of positioning reference signals 150 with the POs 411.

For instance, the indicator 4153 could be indicative of an identity of the UE that is used to determine the timing of the paging occasions 411, e.g., the IMSI. For instance, the indicator 4153 could be indicative of a preference of the UE to keep the timing of the PO fixed and rather set the transmission timing of the transmission of the PRS 150 accordingly.

Subsequently, at 5035, the base station 112-1 then provides a message 4020 (specifically, in the illustrated example an NR Positioning Protocol A Position Update message; see 3GPP Technical Specification TS 38.455 v17.0.0 (2022-04)) to the LMF 139; the message 4020 is indicative of the indicator 4153.

Based on this information, the LMF 139 configures the transmission timing of one or more transmissions of the positioning reference signals 115 accordance with the timing of the paging occasions 411 of the discontinuous reception operation (cf. TAB. 2: example II). A respective configuration indicator 4155 is provided to the base station 112-1 at 5040 using message 4025 (specifically, here an NR Positioning Protocol A Position Activate message). The base station 112-1 passes on this configuration indicator 4155 to the UE 101 using the RRC Release Message 4030, at 5045. The data connection 189 is not established, because the random-access procedure is not completed; the random-access procedure is rather executed for the task of implementing the small data transmission 4004. The UE 101 then-if necessary-adjusts the DRX operation (cf. FIG. 3) based on the configuration indicator 4155 so that it can monitor for the PRS 150; the UE 101 can ensure that its receiver is in the active state during the PMO 412. This exemplifies how the LMF 139 can configure the DRX operation 400 of the UE 101.

Then, at 5050, the base station 112-1 as well as the base station 112-2 transmit PRS 150, i.e., a certain type of DL P-RS. The UE 101 monitors for the PRS 150, i.e., performs positioning measurements at 5050. The respective positioning measurement report 4161 is then provided to the cellular NW 100 using a further mobile originating small data transmission 4005 which includes transmitting a Random-Access preamble 4005 at 5055, receiving a Random-Access Response message 4010 at 5060, and finally transmitting an RRC Resume message 4015 that includes the positioning measurement report 4161 at 5065.

Subsequently, an NR Positioning Protocol A Position report message 4040 is provided to the LMF 139 at 5070; this message 4040 is indicative of the positioning measurement report 4161. If the LMF 139 then, e.g., concludes that the location estimate of the UE 101 can be determined at sufficient accuracy, the LMF 139 can end the positioning by providing, at 5075, an NR Positioning Protocol A Position Deactivate Message 4045 to the base station 112-1; that then provides a respective indicator 4162 as part of the small data transmission 4004 using the RRC Release Message 4030 that is transmitted at 5080 to the UE 101.

FIG. 12 is a signaling diagram of communication between the UE 101 and the cellular NW 100. For instance, the methods according to FIG. 8, FIG. 9 in FIG. 10 can be implemented by the signaling of FIG. 12.

FIG. 12 corresponds to a scenario in accordance with TAB. 2: example I. FIG. 12 relates to a scenario in which the UE performs positioning measurements based on periodic DL P-RS. The BS adjusts the PO of a DRX operation of a UE based on UE request message (cf. TAB. 2: Example I); the PO is adjusted so is time-aligned with the timing of one or more transmissions of P-RS, i.e., time-aligned with PMO. To facilitate this, the UE may, e.g., calculate the time-domain distance between PO defined by its IMSI (i.e., the PO reference time) and the PMO. Then, the UE can propose the PO time offset to be used by the BS (e.g., for RRC_INACTIVE) or AMF (e.g., for RRC_IDLE). Once the time offset is granted by the cellular NW, the UE re-configures the DRX cycle, i.e., aligns the active duration of the DRX cycle with the new PO. Thus, by providing the grant to the PO time offset, the DRX operation of the UE is configured by the cellular NW. After the UE has performed one or more positioning measurements, the UE can initiate a MO-SDT to provide a positioning measurement report (e.g., OTDOA, DL-PRS RSRP, or other information may be included) to the LMF 139 via the serving BS 112-1. It may be possible to aggregate multiple positioning measurement reports. These aspects are now discussed in further detail with reference to FIG. 12.

First, box 5105 corresponds to box 5005; and box 5110 corresponds to box 5010.

At box 5115, a periodic activity with respect to positioning is detected-which is different to the event-triggered positioning at box 5015 of the scenario of FIG. 11.

5120 then corresponds to 5020; and 5125 corresponds to 5025.

At 5130, the RRC Resume message 4015 is transmitted by the UE 101 that includes the indicator 4153. In the illustrated example of FIG. 12, the indicator 4153 may be indicative of a preference of the UE 101 to apply a time offset to the reference timing of the paging occasions that is defined by the identity of the UE 101, specifically the IMSI, so that the paging occasions or time aligned with the transmissions of periodic PRS 150.

The indicator 4153 may also be indicative of the UE intending to monitor for periodic PRS 150.

Accordingly, at 5135, the base station 112-1 provides a message 4205 to the AMF 131. The message 4205 includes an indicator 4171 that is indicative of a request to apply an officer to the paging occasions of the UE 101. Optionally, the time offset may be indicated in the message 4205, e.g., using the information element 4172. Alternatively, it would also be possible that the AMF 131 contacts the LMF 139 to obtain information regarding the transmission timing of the PRS 150.

The AMF 131 then, at 5140, response using a response message 4210 provided to the base station 112-1, the response message 4210 including an information element 4173 that is indicative of the time offset. For instance, a temporary identity may be signaled. This indicator 4173 is then passed on using the RRC Release message 4030 transmitted by the BS 112-1 to the UE 101 at 5145. The UE 101 can then adjust the DRX operation 400 accordingly, i.e., shift the active durations 408 to match the new POs. This exemplifies how the DRX operation of the UE is configured.

5150 then corresponds to 5050; 5155 corresponds to 5055; 5160 corresponds to 5060; 5165 corresponds to 5065; 5170 corresponds to 5070; and 5175 corresponds to 5075; 5180 corresponds to 5080.

Summarizing, techniques have been disclosed which enable aligning the DRX cycle of a UE with a positioning procedure of UEs that operate in a disconnected mode.

POs and PMOs and/or PROs can be time-aligned.

The alignment can be achieved by adjusting the P-RS transmission, e.g., for on-demand PRS transmission, and/or adjusting the PO of the UE, e.g., for periodic P-RS transmission. For adjusting the P-RS transmission, it would be possible to provide DRX-related parameters to the location control node, e.g., the LMF, e.g., using PRS-On-demand Assistance Request message.

For adjusting the PO: The UE report the required PO offset indication to BS or the mobility control node, e.g., AMF. The BS or the mobility control node can then provide the grant of the updated timing of the PO.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

1. A method of operating a network node of a cellular network, the method comprising:
obtaining a request message for positioning of a wireless communication device while the wireless communication device operates in a disconnected mode in which a data connection between the wireless communication device and a radio-access network part of the cellular network is not maintained, and
upon obtaining the request message, configuring a discontinuous reception operation of the wireless communication device to enable one or more transmissions of one or more reference signals for the positioning of the wireless communication device.

2. The method of claim 1,
wherein said configuring of the discontinuous reception operation of the wireless communication device comprises configuring a timing of paging occasions of the discontinuous reception operation in accordance with a transmission timing of the one or more transmissions of the one or more reference signals, the transmission timing being predetermined by a core-network part of the cellular network.

3. The method of claim 2,
wherein said configuring of the timing of the paging occasions comprises configuring a time offset of the paging occasions of the discontinuous reception operation with respect to a respective predetermined reference timing that depends on an identity of the wireless communication device.

4. The method of claim 3,
wherein the time offset is configured by assigning a temporary identity of the wireless communication device.

5. The method of claim 1,
wherein said configuring of the discontinuous reception operation of the wireless communication device comprises configuring a transmission timing of the one or more transmissions of the one or more reference signals in accordance with a timing of paging occasions of the discontinuous reception operation, the timing of the paging occasions being predetermined.

6. The method of claim 5, further comprising:
the location control node obtaining, from the wireless communication device or the radio-access network part, a message indicative of the timing of the paging occasions.

7. The method of claim 2,
wherein the timing of the paging occasions is aligned with the transmission timing of the one or more transmissions of the one or more reference signals.

8. The method of claim 1,
wherein the request message is obtained while the wireless communication device operates in the disconnected mode.

9. The method of claim 1,
wherein the request message is for positioning of the wireless communication device using on-demand reference signals.

10. The method of claim 1,
wherein the request message is for positioning of the wireless communication device using periodic reference signals.

11. The method of claim 1,
wherein the network node is an access node of the radio-access network part of the cellular network or a mobility control node of a core network part of the cellular network,

12. The method of claim 1,
wherein the network node is a location control node of a core network part of the cellular network.

13. A method of operating a network node of a cellular network, the method comprising:
obtaining a request message for positioning of a wireless communication device while the wireless communication device operates in a disconnected mode in which a data connection between the wireless communication device and a radio-access network part of the cellular network is not maintained, and
upon obtaining the request message and depending on at least one of a transmission timing of one or more transmissions of one or more reference signals for the positioning of the wireless communication device or a timing of paging occasions of a discontinuous reception operation of the wireless communication device, configuring an uplink reporting schedule for reporting positioning measurements.

14. The method of claim 13,
wherein the uplink reporting schedule defines an aggregation of multiple positioning measurements executed during a time duration comprising multiple subsequent paging occasions.

15. The method of claim 14,
wherein the uplink reporting schedule defines at least one precondition that triggers the aggregation of the multiple positioning measurements.

16. The method of claim 15,
wherein the at least one precondition depends on the multiple positioning measurements.

17. The method of claim 13,
wherein the uplink reporting schedule defines transmission opportunities for one or more transmissions of the positioning measurements employing a small data transmission protocol prior to establishment of the data connection.

18. A method of operating a wireless communication device connectable to a cellular network, the method comprising:
providing, to the cellular network, a request message for positioning of the wireless communication device while the wireless communication device operates in a disconnected mode in which a data connection between the wireless communication device and a radio-access network part of the cellular network is not maintained,
wherein the request message is provided while the wireless communication device operates in the disconnected mode.

19. The method of claim 18, further comprising:
obtaining, from the cellular network, a configuration message indicative of a transmission timing of one or more transmissions of one or more reference signals for the positioning of the wireless communication device,
wherein the transmission timing of the one or more transmissions of the one or more reference signals is time aligned with a timing of paging occasions of a discontinuous reception operation of the wireless communication device.

20. The method of claim 18, further comprising:
obtaining, from the cellular network, a configuration message indicative of a time offset of paging occasions of a discontinuous reception operation of the wireless communication device with respect to a respective predetermined reference timing that depends on an identity of the wireless communication device.

21-29. (canceled)
